(19) United States
(12) Patent Application Publication
(10) Pub. No.: US 2002/0127154 A1
(43) Pub. Date: Sep. 12, 2002

(54) Exhaust control device and method for manufacture thereof

(76) Inventors: Michael R. Foster, Columbiaville, MI (US); Paul E. Jankowski, Goodrich, MI (US)

Correspondence Address: Vincent A. Cichosz, DELPHI TECHNOLOGIES, INC., 1450 West Long Lake, Troy, MI, 48098, US

(21) Appl. No.: 10/024,108

(22) Filed: Dec. 17, 2001

Related U.S. Application Data
(63) Continuation-in-part of application No. 09/518,573, filed on Mar. 3, 2000.

(51) Int. Cl. B01D 53/88; F01N 3/28

(52) U.S. Cl. 422/179; 422/177

(57) ABSTRACT

Disclosed herein is an exhaust emissions control device and method for making the same. The method for manufacturing the exhaust emission control device comprises: disposing a mat support and a substrate in a shell, wherein the mat support is disposed between the substrate and the shell, and wherein the shell has a roughened surface in physical contact with the mat support.

In one embodiment, the exhaust emissions control device comprises: a shell, a substrate disposed within the shell, and a mat support disposed between the substrate and the shell, wherein the shell has a roughened inner surface in physical contact with the mat support.

### CROSS REFERENCE TO RELATED APPLICATIONS

The present application is a continuation-in-part application of U.S. patent application Ser. No. 09/518,573, filed Mar. 3, 2000, which is hereby incorporated by reference in its entirety.

### TECHNICAL FIELD

The disclosure relates to emission control devices and, more particularly, to an apparatus and method for increasing the static coefficient of friction within an emission control device.

### BACKGROUND OF THE INVENTION

The removal of emissions, such as hydrocarbon, carbon monoxide, nitrogen oxide, particulate matter, and the like, from the exhaust gases of internal combustion engines, in flue gases, and the like, is required to meet increasingly strict environmental standards. One focus area for such exhaust emission reduction has been in the area of post combustion treatment. Namely, post combustion treatment includes the placement of one or more exhaust emission control devices in the exhaust stream downstream of the internal combustion engine or other combustion source. Such exhaust emission control devices include catalytic converters, catalytic absorbers, scrubbers, particulate traps, non-thermal plasma conversion devices, and the like.

The exhaust emission control devices typically comprise a ceramic or metallic substrate having a honeycomb cell or similar structure. Depending upon the particular device, the substrate may comprise a catalyst that functions to convert noxious components of the exhaust gas, such as hydrocarbons (HC), carbon monoxide (CO), and/or nitrogen oxides (NO_{X}), to CO₂, H₂O, and N₂. The substrate is housed within a gas-tight, sheet metal or cast-metal heat resistant housing, can, or shell. Concentrically disposed around the substrate, between the shell and the substrate is a mat support material.

In order to meet governmental mandated exhaust gas emissions standards, there is a burgeoning interest in the use of substrates having a solid density and wall thickness which will yield a significantly weaker structure. If the current art of manufacturing exhaust emission control devices is used with these fragile substrates, there will be significant process losses due to the breaking of the substrate either during manufacturing or after a relatively short life.

Accordingly, there still exists a need for a method and apparatus for retaining a frangible substrate in a housing.

### SUMMARY OF THE INVENTION

Disclosed herein is an exhaust emissions control device and method for making the same. The method for manufacturing the exhaust emission control device comprises: disposing a mat support and a substrate in a shell, wherein the mat support is disposed between the substrate and the shell, and wherein the shell has a roughened surface in physical contact with the mat support.

In one embodiment, the exhaust emissions control device comprises: a shell, a substrate disposed within the shell, and a mat support disposed between the substrate and the shell, wherein the shell has a roughened inner surface in physical contact with the mat support.

In another embodiment, the exhaust emissions control device comprises: a shell, a substrate disposed within the shell, and a mat support disposed between the substrate and the shell, wherein the mat support comprises a porous metal.

The above-described and other features will be appreciated and understood by those skilled in the art from the following detailed descriptions, drawings and appended claims.

### BRIEF DESCRIPTION OF THE DRAWINGS

Reference should now be made to the following detailed description taken in conjunction with the accompanying drawings, which are meant to be exemplary, not limiting, and wherein like elements are numbered alike in the several figures:

FIG. 1 is an isometric view of one embodiment of a substrate having a layer of coating;

FIG. 2 is a partial cross-sectional view of the substrate and coating shown in FIG. 1 with a mat support;

FIG. 3 is an isometric view of another embodiment of the substrate and coating;

FIG. 4 is an isometric view of another embodiment of the substrate and coating;

FIG. 5 is a partial cross-sectional view of another embodiment of the substrate and coating;

FIG. 6 is a partial cross-sectional view of one embodiment of a substrate depicting an air blast stream striking the outer surface of the substrate at an angle of incidence according to the air blasting method;

FIG. 7 is a partial cross-sectional view of another embodiment illustrating the exterior surface of a substrate where the static coefficient of friction between the substrate and mat support has been increased using an air blasting technique;

FIG. 8 is an exploded perspective view of area 8-8 shown in FIG. 7 depicting the entrained material embedded in the outer surface of the substrate;

FIG. 9 is a cross-sectional view of another embodiment for illustrating the exterior surface of a substrate where the outer surface has been roughened using an extrusion technique;

FIG. 10 is a partial illustration of an expanded metal that can be adhered to the interior of a shell to attain a desired Rt; and

FIG. 11 is a cross-sectional view of another embodiment illustrating the exterior surface of a substrate where the outer surface has been roughened using a machining technique.

### DETAILED DESCRIPTION OF THE PREFERRED EMBODIMENTS

As used herein, a roughened surface means a surface where the “vertical” variation to a uniform surface includes a distance of greater than or equal about 0.1 millimeters (mm), with greater than or equal to about 0.3 mm preferred. Also preferred is a vertical variation of less than or equal to about 3.0 mm, with less than or equal to about 1.0 mm more preferred. The shape of the non-uniform surface preferably comprises rapid surface changes, i.e., a change in distance to a uniform surface of greater than or equal to about 50% of the vertical variation within 50% of the vertical height (e.g., the angle from each peak should average greater than or equal to about 45 degrees). The distance between irregularities can be about 0.1 mm to about 10.0 mm with a distance of about 0.5 mm to about 5.0 mm preferred.

The long-term durability of the exhaust emission control device is predicated upon the retention of the substrate. Presently, retention of the fragile substrate is achieved by transmitting relatively high normal forces from the container (shell or housing), through the mat support to the substrate. The gripping force, or the force required to push the substrate out of its position, is equal to the mathematical product of the static coefficient of friction and the normally applied force. For exhaust emission control devices that employ more fragile substrates, the normal forces applied to the substrate must be reduced. The force required to push out a fragile substrate will be less, and consequently, product durability will be compromised, unless the static coefficient of friction is increased.

Increasing the static coefficient of friction between a substrate and a mat support and/or between a mat support and a shell can enhance the retention capabilities of the mat support without increasing the mat support density or the forces applied to the substrate. The static coefficient of friction can be increased by roughening an outer surface of the shell and/or the substrate, by abrading the surface with an abrasive or via machining or the like, and/or by applying a coating or attaching an added part with the desired surface thereto.

The substrate can comprise any material designed for use in a spark ignition or diesel engine environment and capable of operating under exhaust system conditions, that is, temperatures up to and exceeding about 1,000° C. (e.g., depending upon the location of the exhaust emission control device in the exhaust system), exposure to hydrocarbons, nitrous oxides, carbon monoxide, particulate matter (e.g., soot, and the like), carbon dioxide, and/or sulfur, and having sufficient surface area and structural integrity to support a catalyst, if desired. Some possible materials include cordierite, silicon carbide, metal, metal oxides (e.g., alumina, and the like), glasses, and the like, and mixtures comprising at least one of the foregoing materials. Some ceramic materials include “Honey Ceram”, commercially available from NGK-Locke, Inc, Southfield, Mich., and “Celcor”, commercially available from Corning, Inc., Corning, N.Y. These materials can be in the form of foils, porous materials, sponges, and the like, e.g., metallic foils, open pore alumina sponges, and porous ultra-low expansion glasses.

Although the substrate can have any size or geometry, the size and geometry are preferably chosen to optimize surface area in the given converter design parameters. Typically, the substrate has a honeycomb geometry, with the combs being any multi-sided or rounded shape, with substantially square, hexagonal, octagonal or similar shapes preferred due to ease of manufacturing and increased surface area.

Depending upon the type of exhaust emission control device, optionally disposed on and/or throughout the substrate can be a catalyst for converting exhaust gasses to acceptable emissions levels. The catalyst may comprise one or more catalyst materials that are wash coated, imbibed, impregnated, physisorbed, chemisorbed, precipitated, or otherwise applied to the substrate. Possible catalyst materials include metals, such as platinum, palladium, rhodium, iridium, osmium, ruthenium, tantalum, zirconium, yttrium, cerium, nickel, copper, and the like, as well as oxides, alloys, and combinations comprising at least one of the foregoing catalyst materials, and other catalysts.

Located around at least a portion of the substrate is a mat support that can provide structural integrity and insulate the shell and nearby components from high exhaust gas temperatures and the exothermic reaction within the exhaust emission control device. The mat support can comprise an intumescent material (e.g., comprising a vermiculite component), a non-intumescent material, or a combination thereof. The intumescent material, for example, is one which comprises ceramic materials, and other materials such as organic binders and the like, or combinations comprising at least one of the foregoing materials. The vermiculite component is a component that expands with heating to maintain firm uniform compression, or non-uniform compression, if desired. The non-intumescent material, for example, is one that does not contain vermiculite. Non-intumescent materials include materials such as ceramics, metals, and composites and combinations comprising at least one of the foregoing materials. Examples of possible materials include 900HT, 1100HT, and those sold under the trademarks “NEXTEL” and “SAFFIL” by the “3M” Company, Minneapolis, Minn., or those sold under the trademark, “FIBERFRAX” and “CC-MAX” by the Unifrax Co., Niagara Falls, N.Y., and the like. Intumescent materials include materials, sold under the trademark “INTERAM” by the “3M” Company, Minneapolis, Minn., such as Interam 100, as well as those intumescents which are also sold under the aforementioned “FIBERFRAX” trademark by the Unifrax Co., Niagara Falls, N.Y., as well as combinations comprising at least one of the foregoing materials, and others.

The mat support material is disposed around at least a portion of the substrate forming a subassembly that is concentrically disposed within a shell or housing. The choice of material for the shell depends upon the type of exhaust gas, the maximum temperature reached by the substrate, the maximum temperature of the exhaust gas stream, and the like. Suitable materials for the shell can comprise any material that is compatible with the operating conditions and the environment (e.g., capable of resisting under-car salt, temperature, stress, and corrosion). Typically, ferrous materials are employed such as ferritic stainless steels. Ferritic stainless steels can include stainless steels such as, e.g., the 400—Series such as SS-409, SS-439, and SS-441, with grade SS-409 generally preferred.

Also similar materials as the housing, end cone(s), end plate(s), exhaust manifold cover(s), and the like, can be concentrically fitted about the one or both ends and secured to the housing to provide a gas tight seal. These components can be formed separately (e.g., molded or the like), or can be formed integrally with the housing using a methods such as, e.g., a spin forming, or the like.

In order to enhance the structural integrity of the substrate in relation to normal forces, the static coefficient of friction between the substrate and mat support and/or the coefficient of friction between the mat support and the shell is increased. This can be accomplished in various fashions, including by roughening the outer surface of the substrate, roughening the inner surface of the shell, employing a rough mat support material (e.g., having a roughness Rₜ (i.e., the total height (from valley/bottom to peak) of greater than or equal to about 25 micrometers (μm)). Shells and substrates that have not been roughened typically have an Rₜ of less than 4.6 and 7.4 μm, respectively. Preferably, the Rₜ of at least a portion of the shell inner surface and optionally of a portion or all of the substrate, is greater than or equal to about 25 μm, with greater than or equal to about 50 μm more preferred, and greater than or equal to about 100 μm more preferred. It is further preferred to have an Rₜ of less than or equal to about 3,000μm, with an Rₜ of less than or equal to about 1,500 more preferred, and an Rₜ of less than or equal to about 1,000 most preferred. All or a portion of the appropriate surface(s) can be roughened by abrading with an abrasive or via machining, and/or by applying a coating thereto.

As stated, one method for roughening the outer surface of the substrate and/or on the inner surface of the shell is via the use of a coating. The coating can comprise any material that creates a sufficiently roughened surface between substrate and mat support to attain the desired static coefficient of friction and, preferably, that readily binds or otherwise adheres to the substrate. For example, coating can comprise any abrasive material stable in the operating environment (e.g., up to about 1,000° C. or so (depending upon the location of the exhaust emission control device), and exposure to exhaust gases) and which creates rough edges that preferably exhibit a crystallographic habit having the propensity to entangle with the mat support material. Some possible materials include mullite, ferrous materials such as stainless steels, (e.g., melt sprayed such as 409, 420, 439, and the like), silica, pulverized scrap substrate material, calcined/boehmite, alumina, and the like, and mixtures comprising at least one of these materials. These materials are preferably chopped, crushed, or otherwise having a jagged geometry such as needle-like, chopped fibers, particles and the like, to achieve the purpose of the entanglement feature in coating 18 as depicted in FIG. 2. One such material is, “A10” or “HiQ”, commercially available from Alcoa Industrial Chemicals.

Although the roughened surface can be applied/formed on substrate and/or shell at many points during or after the production thereof, as well as by using numerous application methods, the roughened surface is preferably formed while manufacturing the substrate and shell, except in exhaust emission control devices that are assembled by a stuffing method, in this case it may be preferred to form the roughened surface only on the substrate prior to assembly. For example, the substrate can be extruded, dried, thermally treated to about 1,200° C. and subsequently, all or a portion can be coated with the material and then heat treated to about 400° C. to about 600° C. for a sufficient period of time to allow for moisture removal. Meanwhile the shell can be formed via extrusion and subsequent to assembly of the device, a porous metal can be adhered (e.g., welded, bonded or the like), to at least a portion of the interior surface of the shell. Alternatively, the mat support can be a porous metal. If the mat support is a series of layers of porous metal, the outermost layer disposed adjacent to the shell can be optionally adhered to the shell.

For example, the coating for the substrate can be applied by first forming a slurry (hereinafter referred to as “mixture”) of the abrasive material by combining the material with water or another liquid, calcined alumina, peptizable alumina, and combinations comprising at least one of the foregoing materials, and the like. The material is applied to the desired area of the substrate and/or shell via washcoating, imbibing, dipping, painting, spraying, or brushing, as well as combinations comprising at least one of the foregoing techniques, and the like. With respect to the shell, the coating can be applied by adhering a metallic material to the shell, e.g., via plasma spraying, welding, or the like, or by wrapping a porous metal round the mat support and, once assembled, adhering the metal to the shell. Possible metals include any compatible material that can be adhered to the shell and that can be employed in the exhaust system component environment. Some possible metals include ferrous materials, such as stainless steels, and the like.

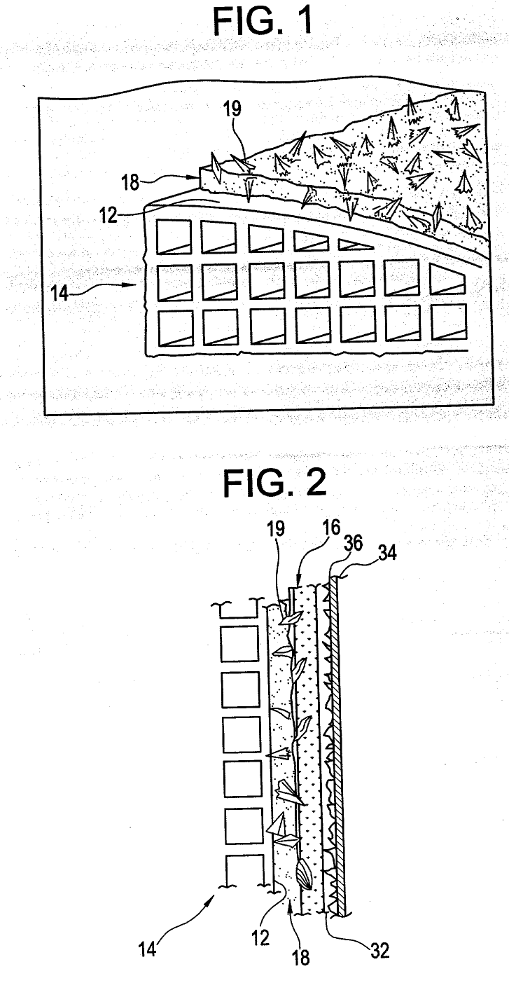

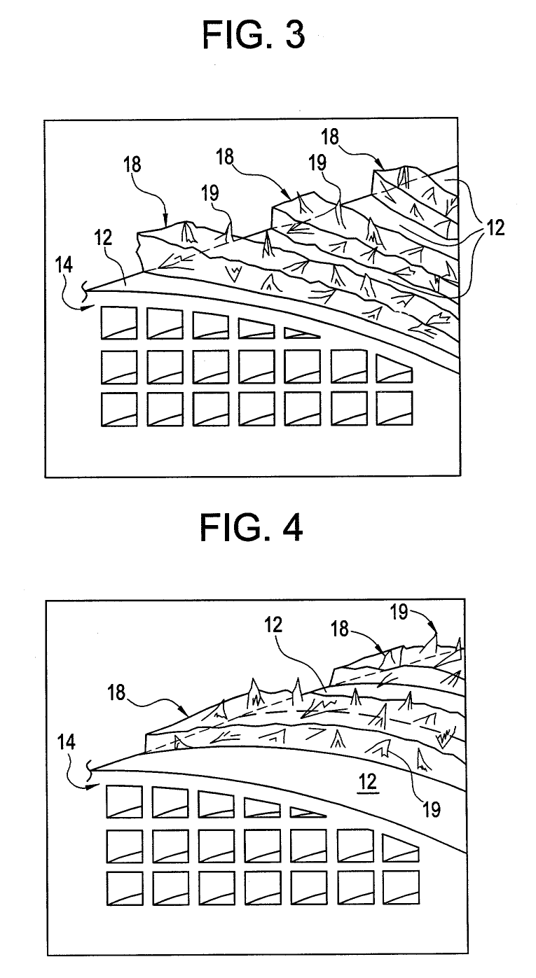

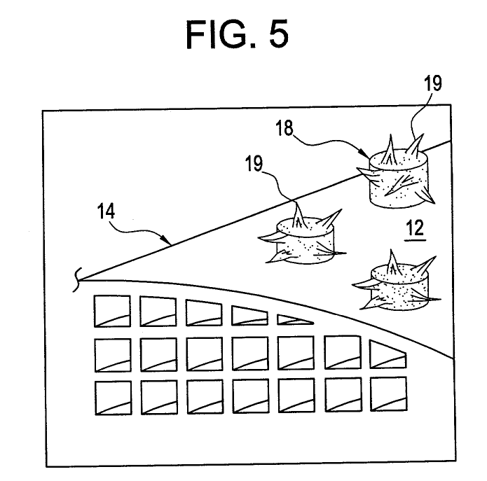

The coating can be applied to a portion or all of the outer surface of the substrate. Some possible embodiments of coating application geometries are illustrated in FIGS. 1, 3, 4, and 5. FIG. 1 illustrates the coating 18 applied to substantially all of the outer substrate surface 12 of the substrate 14. However, the coating 18 can be applied to outer substrate surface 12 in a variety of designs. Coating 18 may be applied in individual strips having a predetermined width and configured parallel to one another on outer substrate surface 12 (FIG. 3). Coating 18 can also be applied in a single strip that wraps concentrically about outer substrate surface 12 in an S-shaped fashion, and the like (FIG. 4). Alternatively, the coating 18 can have a configuration or pattern, other than a stripe, that substantially covers outer substrate surface 12 or preferably covers a plurality of selected areas of outer substrate surface 12 (FIG. 5). Similarly, a coating 36, e.g., metal, can be applied to the inner shell surface 32. (FIG. 2)

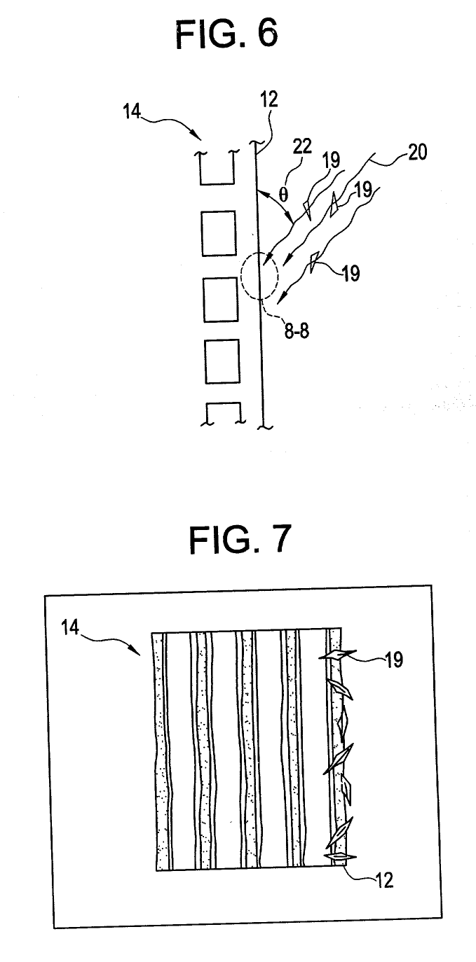

Referring now to FIG. 6, an alternative method for forming a roughened surface, and thereby increasing the static coefficient of friction between substrate 14 and the mat support (not shown) in an exhaust emissions device can be an air blasting method. The air blasting method comprises subjecting outer substrate surface 12 to an air blast 20 at an angle of incidence 22 that preferably impinges upon all or a substantial part of outer substrate surface 12. Optionally, abrasive material 19 can be entrained within an air stream using techniques such as the pneumatic transfer of powders, such that these materials embed within all or a portion of the outer substrate surface 12, for example. Alternatively, the surface can be roughened using a grit that does not substantially adhere to or embed in the outer substrate surface 12 or the inner shell surface 32 (see FIG. 2). A similar process can be used with all or a portion of the interior of the shell.

Air blast 20 and angle of incidence 22 are variably and preferably selected to cause material 19 to become embedded into outer substrate surface 12 (or the inner surface of the shell (not shown)) in a preferably random orientation (See FIGS. 6 and 7). The pressure of air blast 20 is a function of the particle shape of material 19, the hardness of substrate 14 or the shell 34, the desired depth of penetration of outer substrate surface 12 or inner shell surface (not shown in FIG. 6), respectively, and the physical distance between the nozzle and outer substrate surface 12 or the inner shell surface. Angle of incidence 22, indicated by theta (θ) in FIG. 6, is the angle between the surface, e.g., outer substrate surface 12, and the predominant vector describing the air movement.

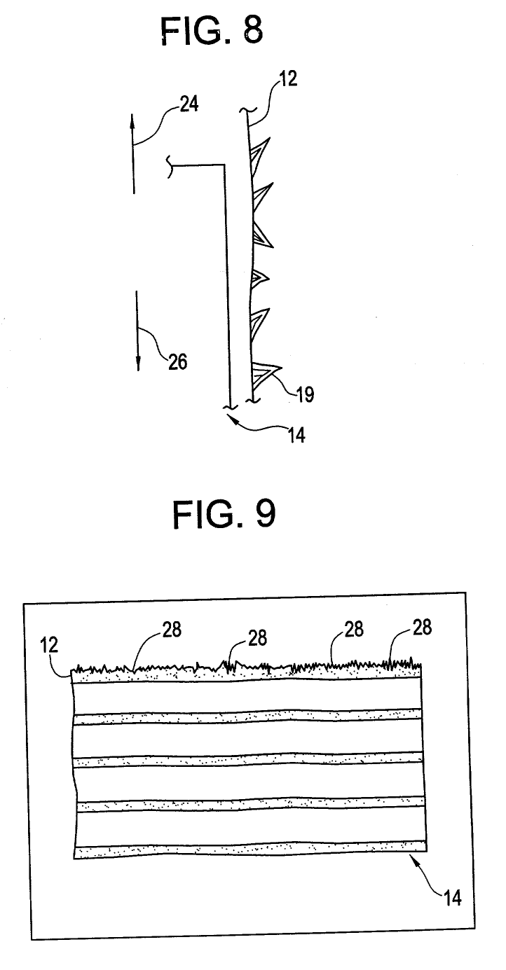

A random orientation of material 19 provides equal resistance to the movement of substrate 14, or shell, regardless of the direction that substrate 14, or shell, moves during operation. If material 19 has the same orientation, e.g. upward and outward, over outer substrate surface 12, then substrate 14 movement will be more difficult in the direction indicated by an arrow 24, than in the direction indicated by an arrow 26 (See FIG. 8). Since movement in either direction is detrimental, movement in either direction is preferably inhibited by creating a random orientation of material 19.

Once material 19 is randomly oriented and embedded in outer substrate surface 12, material 19 will then preferably be “locked” into position by mechanical interference commonly known as under-cutting preferably after drying substrate 14. Substrate can be extruded, dried, and air blasted with material and dried via a conventional thermal processing technique. Typically such thermal processing is achieved by moving the substrate through a furnace with a prescribed temperature profile such that sufficient time is allowed for removal of moisture at a temperature of approximately about 1,000° C. to about 1,300° C.

Referring now to FIG. 9, yet another alternative method for roughening the surface, and thereby increasing the static coefficient of friction between substrate 14 and mat support 16 (and/or between the shell (not shown) and the mat support 16), can be an extrusion technique. The extrusion technique is a mechanical operation that can preferably be performed while manufacturing substrate 14 (and/or shell). As the wet, soft extrudate departs the die, a device contacts at least a portion, and preferably the entirety of outer substrate surface 12 causing a plurality of disruptions 28 on outer substrate surface 12. The device may be a spurred wheel, needle roller or any other device capable of causing disruptions 28. The disruptions 28 are preferably formed on outer substrate surface 12 without breaking substrate 14 or exceeding a predetermined depth in outer substrate surface 12 that would weaken or otherwise adversely effect the structural integrity of the substrate 14.

The disruptions 28 can have any geometry, including dimples, divots, squares, triangles, rectangles, pentagons, hexagons, diamonds, circles, lines, combinations comprising at least one of the foregoing geometries and the like. The best size, number and pattern of disruptions 28 will be a function of the mass of substrate 14 (or the shell 34, depending where they are located), design life of the exhaust emissions control device, and the frequency and amplitude of the vibrations experienced by the exhaust emissions control device when operating. The visco-elastic behavior of mat support material 16 will enable it to engage disruptions 28 when placed under pressure during manufacturing.

Similar to the extrusion method for the substrate 12, the inner surface of the shell can be roughened, thereby increasing the coefficient of friction between the mat support 16 and the shell 34, by the manner in which the shell is formed or processed. For example, all or a portion of the shell inner surface can be roughened by rolling a sheet of steel between rollers where one or both rollers has grooves or punches that form corresponding grooves, cavities, or disruptions in at least a portion of one surface of the metal (e.g., a knurling tool), struck with a die surface that has protrusions or cavities to form opposing disruptions in the shell; heat treated to form an adherent oxide coating; sprayed with molten metal; acid etched to form a rough surface; electroplated with a rough surface; impacting the surface with objects at sufficient velocity to locally deform the surface; and/or by adding and securing a second material with voids or protrusions, such as porous metal (e.g., expanded metal, screen, or the like), to the surface in contact with the mat support; and the like, as well as combinations comprising at least one of the foregoing methods.

For example, the surface can be roughened by wrapping all or a portion of the mat support with an metal in the form of a screen, expanded metal, or other perforated metal. Once the mat support with the metal is disposed within the shell the metal can be adhered to the interior of the shell. The perforations in the metal can have various sizes and geometries sufficient to attain the desired Rₜ. For example, for the expanded metal illustrated in FIG. 10, the opening width “w” can be about 12.0 millimeters (mm), with an opening height “h” of about 6.0 mm. The thickness (e.g., Rₜ) of the strands 40 can be about 1.5 mm, with a strand width of about 0.7 mm. This expanded metal can attached to selected portions of the shell or disposed along the entire interior surface of the shell.

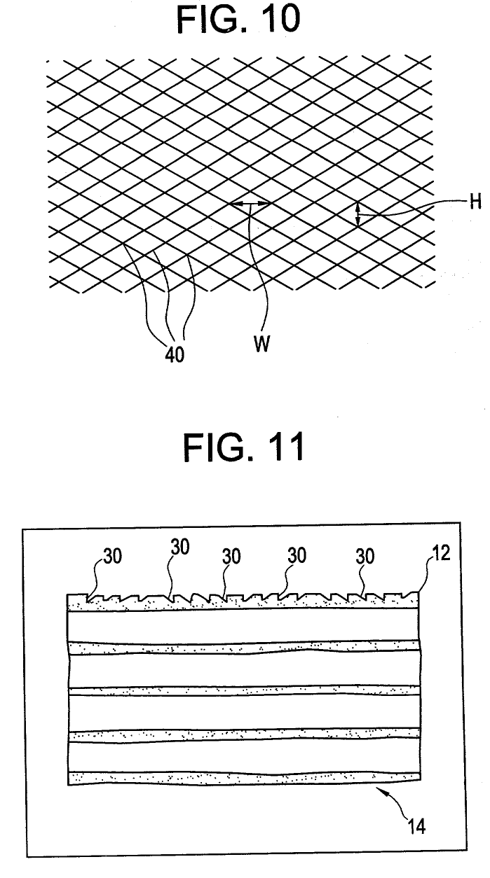

Referring now to FIG. 11, another alternative method for increasing the static coefficient of friction between substrate 14 and mat support material 16 or the shell 34 and the mat support material 16 can be a machining method. The machining method can preferably be performed while manufacturing the component (i.e., substrate 14 and/or shell 34). The appropriate surface of the component can be subjected to a cutting tool, wire brush, or similar device, or a combination comprising at least one of these techniques, that forms a plurality of troughs 30 or other shapes in the surface without breaking the component or exceeding a predetermined depth of the surface that would weaken or otherwise adversely affect the structural integrity of the component. For the substrate, the troughs 30 are preferably formed once substrate 14 is dry and before undergoing thermal processing.

The troughs 30 can have any geometry, including irregular, jagged configurations, pointed geometries, dimples, divots, squares, triangles, rectangles, pentagons, hexagons, diamonds, circles, lines, combinations comprising at least one of the foregoing geometries and the like. The preferred size, number, and pattern of troughs 30 will be a function of the mass of the component, design life of the exhaust emissions control device, and the frequency and amplitude of the vibrations experienced by the exhaust emissions control device when operating. As with the disruptions 28, the visco-elastic behavior of mat support material 16 will enable it to engage troughs 30 when placed under pressure during operation or while being manufactured.

Various assembly methods can be employed to form the completed exhaust emission control device, e.g., stuffing method, clamshell assemblies, shrink-to-fit assemblies, tourniquet assemblies, and the like. The type of method employed is chosen mostly depending upon which surfaces have been roughened (e.g., the substrate and/or the shell). When the shell-to-mat support interface is to have an increase coefficient of friction, the exhaust emission control device can be formed, for example, by employing a stuffing method. With this method, the substrate is wrapped with the mat, and a rough material such as “expanded metal” that can be stuffed with the mat support and substrate into the shell. This rough material can then be attached to the shell, e.g., by welding, bonding, or other methods.

Alternatively, where the shell is roughened prior to assembly, e.g., where a molten metal sprayed shell is employed, the shell longitudinal weld can be completed after the mat support wrapped substrate is stuffed into the shell into the shell. The open shell edges can then be squeezed together and welded. Alternatively, a larger diameter shell can be employed (i.e., larger than the size typically employed with the particular mat/substrate combination) such that the mat support wrapped substrate could be easily stuffed into the shell. The shell's diameter would then be reduced, e.g., by a sizing (squeezing) operation.

Testing was completed on various roughened substrate-mat-shell designs for substrate load deflection as compared to a baseline, i.e., a substrate-mat-shell without a roughened surface. All designs, except the expanded metal design, comprised 1 gram per cubic centimeter (g/cc) mat density using several wraps of 1050 grams per square meter (g/m²) of 3M Interam 100 mat, cut to the 1 g/cc mat density. The mat density of the expanded metal sample was about 1.04 g/cc. Heat treatment comprised furnace heating to 500° C. for 1 hour. After the load deflection test, the designs were cold vibration tested (CM 25301) until failure. The testing was conducted with a white noise spectrum starting at 10 G/s for 1 hour, vibration was then increased to 20 G's for 1 hour, increased to 28 G's for 1 hour, and finally to 40 G's until failure occurred. The results are illustrated in Table 1.

TABLE 1

| Sample | Average time to failure |
|---|---|
| baseline | 136 minutes |
| sand coated substrate, metal sprayed shell | 175 minutes |
| sand coated substrate, expanded metal lined shell | 410 minutes |

The results revealed that a substantial improvement was attained with a sanded substrate surface combined with an expanded metal added to the mat-to-shell interface (namely surviving the vibration test for 410 minutes versus 136 minutes for the baseline); i.e., a greater than 3 to 1 time to failure improvement.

There are a number of advantages associated with the enumerated methods for increasing the static coefficient of friction between the substrate and mat support, and/or the mat support and the shell in an exhaust emissions control device. First, when wrapping a mat support around a substrate having a coated surface, or a plurality of disruptions and/or troughs, the entangling factor of the substrate will intermesh and lock with the mat support. Similarly, once disposed within a shell with a coated surface, or a plurality of disruptions and/or troughs, the entangling factor of the shell will intermesh and lock with the mat support. Consequently, the substrate's longitudinal bi-directional movement caused by exhaust system vibrations will be retarded during operation of the exhaust emissions control device due to the increased static coefficient of friction and lack of movement. Second, a more fragile substrate can be employed when manufacturing a exhaust emissions control device due to the increased static coefficient of friction. Third, a greater gripping force for holding a substrate in place within the exhaust emissions control device can be attained at a lower applied normal force, thereby reducing the probability of crushing the substrate while manufacturing or operating the exhaust emissions control device.

Additional advantages are associated with assembly. For example, without a roughened surface at the substrate-to-mat support interface, the mat support can slide on the substrate during “stuffing” of a mat support wrapped substrate into a shell. The amount of slippage can be enough to cause the mat support to overhang one end of the substrate and the mat support to stop short of the intended point on the substrates opposing end. This can cause non-uniform support of the substrate and subsequent damage.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for manufacturing an exhaust emission control device comprising:
disposing a mat support and a substrate in a shell, wherein the mat support is disposed between the substrate and the shell, and wherein the shell has a roughened surface in physical contact with the mat support.

2. The method recited in claim 1, further comprising forming the roughened surface by coating at least a portion of an inner surface of the shell with a material having a plurality of rough edges.

3. The method recited in claim 2, wherein the material selected from a group consisting of ferrous materials, and mixtures comprising at least one ferrous material.

4. The method recited in claim 2, further comprising plasma spraying.

5. The method recited in claim 1, further comprising forming the roughened surface by a method selected from a group consisting of air blasting, classic machining, extrusion technique, rolling a sheet of shell material between rollers, wherein one or both rollers has grooves or punches, striking a die surface that has protrusions to form opposing shapes in the shell material, forming an oxide coating, spraying with molten metal, acid etching, electroplating, impacting the shell with objects, securing a second material comprising voids and/or protrusions to the shell, and combinations comprising at least one of the foregoing methods.

6. The method recited in claim 1, further comprising forming the substrate with a roughened outer substrate surface.

7. The method recited in claim 6, further comprising roughening an outer substrate surface by a method selected from a group consisting of air blasting, machining, coating, extrusion technique, and a combination comprising at least one of the foregoing methods.

8. The method recited in claim 7, wherein the roughening further comprises using a wire brush or a cutting tool.

9. The method recited in claim 7, wherein the roughening of the outer surface further comprises embedding a material in the outer substrate surface.

10. The method recited in claim 9, wherein the material comprises a plurality of rough edges, and wherein the material is selected from the group consisting of mullite, silica, pulverized scrap substrate material, calcined/boehmite, alumina, and mixtures comprising at least one of the foregoing materials.

11. The method recited in claim 7, further comprising embedding a material in or on at least a portion of an inner surface of the shell.

12. The method recited in claim 11, wherein the material comprises a plurality of rough edges, and wherein the material is selected from the group consisting of ferrous materials and mixtures comprising at least one ferrous material.

13. The method recited in claim 7, further comprising machining substantially all of the inner surface.

14. The method recited in claim 1, further comprising wrapping the mat support around at least a portion of the substrate to form a wrapped substrate, wrapping at least a portion of the wrapped substrate with porous metal to form a metal wrap, and stuffing the metal wrap in the shell.

15. The method recited in claim 14, further comprising adhering the porous metal to the shell.

16. The method recited in claim 1, wherein the roughened surface is a portion of an inner surface of the shell disposed adjacent to the mat support.

17. The method recited in claim 1, further comprising embedding a material in or on at least a portion of an inner surface of the shell.

18. The method recited in claim 17, wherein the material comprises a plurality of rough edges, and wherein the material is selected from the group consisting of ferrous materials and mixtures comprising at least one ferrous material.

19. The method recited in claim 1, further comprising machining at least a portion of an inner surface of the substrate to form the roughened surface.

20. The method recited in claim 1, wherein the roughened surface has a Rₜ of about 25 μm to about 3,000 μm.

21. The method recited in claim 20, wherein the Rₜ is about 50 μm to about 1,500 μm.

22. The method recited in claim 21, wherein the Rₜ is about 100 μm to about 1,000 μm.

23. The method recited in claim 1, further comprising roughening at least a portion of an inner surface of the shell, wherein the roughening is accomplished with a method selected from the group consisting of rolling with at least one roller comprising grooves or punches, striking the inner surface with a die surface that has protrusions or cavities, heat treated the inner surface to form an oxide coating, spraying with molten metal, acid etching, electroplating with a rough surface; impacting the inner surface with objects at sufficient velocity to locally deform the inner surface, securing a second material with voids or protrusions to the inner surface, and combinations comprising at least one of the foregoing methods.

24. An exhaust emissions control device, comprising:
a shell;
a substrate disposed within the shell; and
a mat support disposed between the substrate and the shell, wherein the shell has a roughened inner surface in physical contact with the mat support.

25. The exhaust emissions control device recited in claim 24,
wherein an outer surface of the substrate comprises a coating that increases the coefficient of friction between the outer surface and the mat support.

26. The exhaust emissions control device recited in claim 24,
wherein the inner surface comprises a coating that increases the coefficient of friction between the inner surface and the mat support.

27. The exhaust emissions control device recited in claim 24, further comprising a sheet of expanded metal disposed between the shell and the mat support and attached to the shell.

28. The exhaust emissions control device recited in claim 24,
wherein the roughened surface has a Rₜ of about 25 μm to about 3,000 μm.

29. The exhaust emissions control device recited in claim 28,
wherein the Rₜ is about 50 μm to about 1,500 μm.

30. The exhaust emissions control device recited in claim 29,
wherein the Rₜ is about 100 μm to about 1,000 μm.

31. The exhaust emissions control device recited in claim 24,
wherein the roughened surface is a portion of an inner surface of the shell disposed adjacent to the mat support.

32. An exhaust emissions control device, comprising:
a shell;
a substrate disposed within the shell; and
a mat support disposed between the substrate and the shell, wherein the mat support comprises a porous metal.

33. The exhaust emissions control device recited in claim 32,
wherein the shell further comprises a roughened inner surface.

34. The exhaust emissions control device recited in claim 33,
wherein the roughened inner surface comprises a portion of the mat support adhered to the shell.
